(19) United States
(12) Patent Application Publication
(10) Pub. No.: US 2026/0249588 A1
(43) Pub. Date: Aug. 27, 2026

(54) Multilayer Leather Product And Method For The Preparation Thereof

(71) Applicant: DAVID LEATHER EXPRESSIONS SRL, Firenze (IT)

(72) Inventor: Paolo QUIRICI, Pisa (IT)

(21) Appl. No.: 18/714,278

(22) PCT Filed: Dec. 2, 2022
(86) PCT No.: PCT/IB2022/061703

§ 371 Date: May 29, 2024

(30) Foreign Application Priority Data
Dec. 3, 2021 (IT) 102021000030659

(51) Int. Cl. B32B 9/04; B32B 9/02; B32B 37/12; B32B 38/00

(52) U.S. Cl. CPC B32B 9/04; B32B 9/025; B32B 37/12; B32B 38/145; B32B 2250/02; B32B 2307/7376; B32B 2317/08

(57) ABSTRACT

The present invention concerns a multilayer leather product having a three-dimensional decoration, and a method for the production thereof.

### FIELD OF THE INVENTION

The present invention concerns a multilayer leather product having a three-dimensional decoration, and a method for the production thereof.

### BACKGROUND ART

In everyday life, leather products are widely used in various sectors for the production of various items such as bags, satchels, items of clothing, office items, accessories, and shoes, thanks to the combination of excellent mechanical properties and aesthetic value associated with these items.

In the leather processing sector, different three-dimensional decoration techniques are known, which are used in order to customize the items with geometric patterns, texts, numbers, or symbols.

Such decoration techniques envisage applying on the outer surface of the leather product paints, lacquers, resins, or accessories (studs, stencils) capable of forming relief decorative patterns on it. However, said decoration techniques to date have a number of technical and performance limitations. In particular, the application of three-dimensional decorations on a leather product can change the mechanical and surface texture properties thereof, giving rise to, for example, local inhomogeneity and rigidity that reduce the aesthetic value of the items made. The three-dimensional decorations applied can also detach themselves from the surface of the leather, thereby causing the desired decorative effect to be lost and even damaging the leather.

### SUMMARY OF THE INVENTION

Aim of the present invention is therefore to provide a new leather product and a method for the manufacture thereof, capable of showing a three-dimensional decoration that overcomes the technical and performance limitations highlighted by the products and by the techniques known to date. In particular, aim of the present invention is to provide a new leather product that has a three-dimensional decorative effect that does not undesirably change the mechanical and surface texture properties of the product itself, while at the same time being able to maintain the desired decorative effect without having phenomena of detachment from the surface of the leather and without damaging the latter.

In accordance with the present invention, the Applicant has surprisingly found that it is possible to pursue this and other advantageous aims through a multilayer leather product incorporating a relief pattern inside.

In particular, the present invention concerns in a first aspect thereof a multilayer leather product comprising a first layer of a first material and a second layer of a second material coupled to said first layer, wherein at least one of said first and second material is leather and wherein, between said first and said second layer, at least one relief pattern is arranged.

The Applicant has in fact surprisingly found that it is possible to obtain a three-dimensional decorative effect that does not undesirably change the mechanical and texture properties of the leather products, while at the same time being able to maintain the desired decorative effect without having detachment phenomena and without damaging the leather, providing and incorporating a relief pattern within a multilayer leather product.

In a further aspect thereof, the present invention further concerns a method for producing a multilayer leather product comprising the steps of:
(a) providing a first layer of a first material;
(b) providing at least one relief pattern on at least one surface of said first layer of said first material;
(c) coupling a second layer of a second material onto said first layer of said first material;
wherein said at least one relief pattern is arranged between said first and second layer and wherein at least one of said first and second material is leather.

The advantages and features of said further aspect have already been highlighted with reference to the first aspect of the invention and are not repeated here.

Thanks to the three-dimensional decorative effect obtained, which does not undesirably change the mechanical and surface texture properties thereof, the product according to the invention is advantageously usable for the manufacture of various leather items.

In a still further aspect thereof, the present invention further concerns an item comprising the multilayer leather product according to the present invention, selected from the group consisting of: a bag, a wallet, a belt, a satchel, an item of clothing, an office item, an accessory, a shoe, a particular valuable covering for furnishing elements, such as armchairs or sofas, or motor vehicles, such as seats or other accessories such as steering wheels, knobs, etc.

### BRIEF DESCRIPTION OF THE DRAWINGS

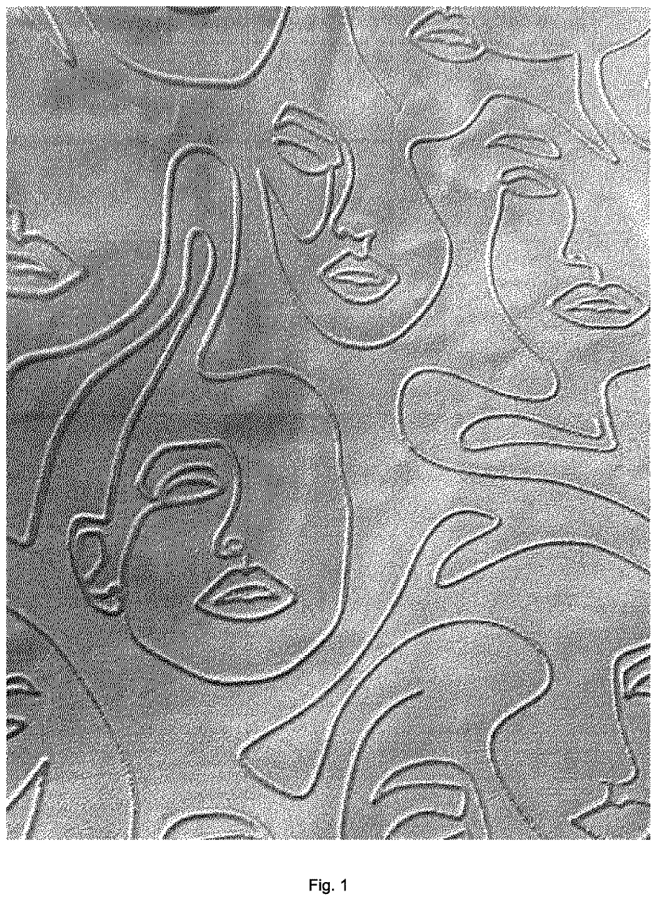

In FIG. 1 a photographic image of the multilayer leather product obtained according to the method of the invention described in example 1.

### DETAILED DESCRIPTION OF THE INVENTION

The present invention concerns in a first aspect thereof a multilayer leather product comprising a first layer of a first material and a second layer of a second material coupled to said first layer, wherein at least one of said first and second material is leather and wherein, between said first and said second layer, at least one relief pattern is arranged.

The Applicant has in fact surprisingly found that it is possible to obtain a three-dimensional decorative effect that does not undesirably change the mechanical and texture properties of the leather products, while at the same time being able to maintain the desired decorative effect without having detachment phenomena and without damaging the leather, providing and incorporating a relief pattern within a multilayer leather product.

In the context of this description and in the subsequent claims, all numerical magnitudes indicating quantities, parameters, percentages, and so on are to be understood as preceded in all circumstances by the term “about” unless otherwise indicated. In addition, all the ranges of numerical magnitude include all possible combinations of the maximum and minimum numerical values and all the possible intermediate ranges, in addition to those specifically indicated below.

The present invention can be presented in one or more of its aspects or one or more of the preferred characteristics reported below, which can be combined with one another according to the application requirements.

Preferably, in the leather product according to the present invention said at least one relief pattern comprises at least one continuous or discontinuous sign selected from the group comprising: a geometric pattern, a text, a number, a figure, a design, and a symbol. Combinations of the same are of course possible.

In the product according to the present invention, at least one of said first and second material is leather. In other words, at least one of said first and second layer is leather.

In one embodiment, said at least one leather layer of the multilayer product according to the present invention is a “crust” layer, thereby indicating a lower layer of the leather, advantageously obtainable by a leather splitting process.

In another embodiment, said at least one leather layer of the multilayer product according to the present invention is a so-called “grain” leather, thereby indicating an upper layer of the leather, advantageously obtainable by a leather splitting process.

In one embodiment of the product according to the present invention, one of said first and second material is other than leather and advantageously selected from: a fabric, a non-woven fabric, a synthetic material and more generally any type of material that can be processed according to the technique of the invention.

In a further particularly preferred embodiment, in the leather product according to the present invention said first and said second material are both leather. Preferably, in this case said first material is a leather crust and said second material is a leather grain, advantageously obtainable by a leather splitting process.

Preferably, said first layer has a thickness comprised between 0.3 and 1.1 mm, more preferably between 0.5 and 0.9 mm.

Preferably, said second layer has a thickness comprised between 0.1 and 0.4 mm, more preferably between 0.2 and 0.3 mm.

In a further aspect thereof, the present invention further concerns a method for producing a multilayer leather product comprising the steps of:
(a) providing a first layer of a first material;
(b) providing at least one relief pattern on at least one surface of said first layer of said first material;
(c) coupling a second layer of a second material onto said first layer of said first material;
wherein said at least one relief pattern is arranged between said first and second layer and wherein at least one of said first and second material is leather.

The advantages and features of said further aspect have already been highlighted with reference to the first aspect of the invention and are not repeated here.

The method according to the present invention comprises the step (a) of providing a first layer of a first material, which in step (c) is coupled with a second layer of a second material.

In the method according to the present invention at least one of said first and second material is leather. In other words, at least one of said first and second layer is leather.

In one embodiment, said at least one leather layer is a “crust” layer, thereby indicating a lower layer of the leather, advantageously obtainable by a leather splitting process.

In another embodiment, said at least one leather layer is a so-called “grain” leather, thereby indicating an upper layer of the leather, advantageously obtainable by a leather splitting process.

In one embodiment of the method according to the present invention, one of said first and second material is other than leather and advantageously selected from: a fabric, a non-woven fabric, a synthetic material and more generally any type of material that can be processed according to the technique of the invention.

In a further particularly preferred embodiment, in the method according to the present invention said first and said second material are both leather. Preferably, in this case said first material is a leather crust and said second material is a leather grain, advantageously obtainable by a leather splitting process.

Preferably, said first layer has a thickness comprised between 0.3 and 1.1 mm, more preferably between 0.5 and 0.9 mm.

Preferably, said second layer has a thickness comprised between 0.1 and 0.4 mm, more preferably between 0.2 and 0.3 mm.

The leather splitting process that can be used to obtain said first or second layer of leather is a conventional process known in the industry, in which with suitable leather splitting machines provided with very sharp blades the transversal cutting of the leather is carried out in order to bring it to a constant thickness along its entire profile.

The method according to the invention envisages a step (b) of providing at least one relief pattern on at least one surface of said first layer of said first material.

In said step (b) said at least one relief pattern may be arranged according to any technique known to the person skilled in the art.

In one embodiment, in said step (b) said at least one relief pattern is arranged on said at least one surface by means of a printing technique.

Preferably, said printing technique is selected from the group consisting of: screen printing, resin coating, 3D Doming.

In another embodiment, in said step (b) said at least one relief pattern is applied on said at least one surface, preferably by application of a stencil or of one or more preformed decorative elements. Said application preferably comprises the step of gluing said relief pattern, for example a stencil, on said surface.

Preferably, said at least one relief pattern comprises at least one continuous or discontinuous sign selected from the group comprising: a geometric pattern, a text, a number, a figure, a design and a symbol. It is understood that combinations of the same are of course also possible.

Preferably said relief pattern has a thickness comprised between 0.1 and 2.2 mm, more preferably between 0.2 and 2 mm.

The method according to the invention provides a step (c) of coupling a second layer of a second material onto said first layer of said first material so as to interpose the at least one relief pattern between said first and second layer. In this way, the relief pattern provided in step (b) of the method according to the present invention is incorporated into the multilayer leather product obtaining on it a three-dimensional decorative effect that does not undesirably change the mechanical and surface texture properties thereof, while at the same time being able to maintain the desired decorative effect without having detachment phenomena and without damaging the leather itself.

Said coupling step can be carried out according to any technique known to the person skilled in the art.

Preferably, said step (c) of coupling is carried out by gluing said second layer on said first layer.

Adhesives suitable for coupling said second layer on said first layer are for example water-based adhesives, such as for example polymer solutions or suspensions, for example based on natural rubber latexes, polychloroprene or polyurethanes, even modified.

Thanks to the three-dimensional decorative effect obtained, which does not undesirably change the mechanical and surface texture properties thereof, the product according to the invention is advantageously usable for the manufacture of various leather items.

In a still further aspect thereof, the present invention further concerns an item comprising the leather product according to the present invention, selected from the group consisting of: a bag, a satchel, an item of clothing, an office item, an accessory, a shoe, a particular valuable covering for furnishing elements, such as armchairs or sofas, or motor vehicles, such as seats or other accessories such as steering wheels, knobs, etc.

Further features and advantages of the invention will be more evident from the following Examples, which are intended only for illustrative and non-limiting purposes thereof.

### EXPERIMENTAL PART

### Example 1

A chrome-tanned calfskin leather with a thickness of approximately 1.1 mm was subjected to a splitting process obtaining a layer of first material (grain) with a thickness of 0.3 mm and a layer of second material (crust) with a thickness of 0.8 mm.

The crust was screen-printed to print a 0.4 mm thick relief profile, after which the screen-printed crust was again coupled to the grain obtained from the previous splitting process, using commercial adhesives based on modified natural rubber latex.

The resulting product, of which an image is reproduced in FIG. 1, showed characteristics of extraordinary softness to the touch, particular aesthetic value, profile uniformity as well as resistance to friction over time, without wear or degradation of the reliefs, thanks to the protection of the same conferred by the second covering layer of leather, which made the multilayer leather product, obtained according to the method of the invention, particularly suitable for the manufacture of items of great value to be destined to the world of luxury, automotive and furniture.

### Example 2

A vegetable-tanned calfskin leather with a thickness of approximately 1.0 mm was subjected to a splitting process from which a layer of first material (grain) with a thickness of 0.3 mm and a layer of second material (crust) with a thickness of 0.7 mm were obtained.

The crust was destined for other processings while the grain was used for the manufacture of a multilayer product in which the layer of the first material (grain) was coupled to a fabric material with a thickness of 0.8 mm, screen-printed with a relief print with a thickness of 0.5 mm, using a modified polyurethane-based adhesive.

The resulting multilayer product appeared to emphasise on its surface the aesthetic qualities of the leather, thanks to the use of the grain which made it possible to preserve the typical and appreciated appearance of the leather, and the advantages in terms of elasticity due to the use of the fabric, which made it possible, among other things, to obtain a leather-based multilayer product at a lower cost than that obtained in example 1.

The item also proved to be particularly resistant and easy to be processed.

The method of the invention therefore made it possible to obtain a new item that can be used in markets other than luxury, such as furniture and automotive, in which a significant aesthetic value and wear resistance are required, but lower costs.

1. A multilayer leather product comprising a first layer of a first material and a second layer of a second material coupled to said first layer, in which at least one of said first and second material is leather and in which, between said first and said second layer, at least one relief pattern is arranged.

2. The leather product according to claim 1, wherein said at least one relief pattern comprises at least one continuous or discontinuous sign selected from the group consisting of: a geometric pattern, a text, a number, a figure, a design, and a symbol.

3. The leather product according to claim 1, wherein said relief pattern has a thickness comprised between 0.1 and 2.2 mm.

4. The leather product according to claim 1, wherein said first and said second materials are both leather.

5. The leather product according to claim 1 wherein said first layer of a first material has a thickness comprised between 0.3 and 1.1 mm.

6. The leather product according to claim 1 wherein said second layer of a second material has a thickness comprised between 0.1 and 0.4 mm.

7. A method for producing a multilayer leather product comprising the steps of:
(a) providing a first layer of a first material;
(b) providing at least one relief pattern on at least one surface of said first layer of said first material;
(c) coupling a second layer of a second material onto said first layer of said first material;
wherein said at least one relief pattern is interposed between said first and second layer and wherein at least one of said first and second material is leather.

8. The method according to claim 7, wherein in said step (b) said at least one relief pattern is arranged on said at least one surface by means of a printing technique.

9. The method according to claim 8, wherein said printing technique is selected from the group consisting of: screen printing, resin coating, 3D doming.

10. The method according to claim 7, wherein said at least one relief pattern comprises at least one continuous or discontinuous sign selected from the group consisting of: a geometric pattern, a text, a number, a figure, a design, and a symbol.

11. The method according to claim 7, wherein said first and said second material are both leather.

12. The method according to claim 7, wherein said coupling step (c) is carried out by gluing said second layer on said first layer.

13. An item comprising the leather product according to claim 1 or obtained by the method according to claim 7, selected from the group consisting of: a bag, a satchel, an item of clothing, an office item, an accessory, a shoe, a covering for furnishing elements, such as armchairs or sofas, or motor vehicles, such as seats or other accessories such as steering wheels, knobs.

14. The leather product according to claim 3, wherein said relief pattern has a thickness comprised between 0.2 and 2 mm.

15. The leather product according to claim 5, wherein said first layer of a first material has a thickness comprised between 0.5 and 0.9 mm.

16. The leather product according to claim 6, wherein said second layer of a second material has a thickness comprised between 0.2 and 0.3 mm.
